(19) United States
(12) Patent Application Publication
(10) Pub. No.: US 2025/0126554 A1
(43) Pub. Date: Apr. 17, 2025

(54) DETECTING NETWORK IMPAIRMENTS

(71) Applicant: Promptlink Communications, Inc., Oceanside, CA (US)

(72) Inventors: Foad TOWFIQ, Vista, CA (US); Alexander PODAREVSKY, Oceanside, CA (US)

(21) Appl. No.: 18/917,807

(22) Filed: Oct. 16, 2024

Related U.S. Application Data
(60) Provisional application No. 63/544,381, filed on Oct. 16, 2023.

(51) Int. Cl. H04W 52/02

(52) U.S. Cl. CPC H04W 52/0212

(57) ABSTRACT

An impairment in a network is identified and information (e.g., frequency noise ingress and/or signal leakage and/or location in the network) about the impairment is determined, thereby enabling a network operator to quickly and accurately find, prioritize, and repair network impairments.

### CROSS-REFERENCE TO RELATED APPLICATIONS

This application claims priority to U.S. Provisional Patent Application No. 63/544,381, entitled “DETECTING NETWORK IMPAIRMENTS,” filed Oct. 16, 2023, the contents of which are incorporated herein by reference in its entirety.

### FIELD

The present disclosure relates generally to detecting and localizing network impairments based on a transmit power and, in particular, to techniques for detecting impairments that contribute to noise ingress and/or signal leakage.

### BACKGROUND

Service providers (e.g., operators) provide customers (e.g., subscribers) with services, such as multimedia, audio, video, telephony, data communications, wireless networking, and wired networking. Service providers provide such services by deploying one or more electronic devices at their customers' premises, and then connecting the deployed electronic device to the service provider's network or infrastructure. The deployed electronic devices are often called Customer Premise Equipment (CPE). For example, a cable company delivers media services to customers by connecting an electronic device, such as a set-top box or a cable modem, located at customer's premise to the cable company's network. This CPE is the device that the service provider uses to deliver the service to the customer.

Networks, such as those maintained by service providers or their customers, may have noise caused by impairments, which can cause service degradation and customer dissatisfaction. Examples of impairments include loose or corroded connectors, damaged cables, and flooded amplifiers. Over time, as the network ages, the severity and number of impairments increase. Service providers face challenges in identifying the type of noise in the network and localizing the noise in the network to fix the impairments in a timely manner so as to limit the impacts of service degradation or outage of their customers.

### SUMMARY

Some techniques for identifying impairments on a data network are unreliable, inaccurate, and/or inefficient. For example, some techniques do not identify particular types of impairments and/or are unable to identify the location where noise caused by the impairment(s) is entering into or originating within the network. For another example, some techniques do not identify network impairments that are causing signal leakage out of the network. Other techniques do not identify the leakage frequencies of network signal leakage.

In accordance with some embodiments, a method is described. The method comprises: determining an in-channel frequency response of a first channel of a first set of one or more channels of a first device; determining a first transmit power level of the first channel; determining a first received power level of the first channel; determining a first respective transmit power of the first channel based on the in-channel frequency response of the first channel, the first transmit power level of the first channel, and the first received power level of the first channel; determining an in-channel frequency response of a second channel of the first set of one or more channels of the first device; determining a second transmit power level, different from the first transmit power level, of the second channel; determining a second received power level, different from the first received power level, of the second channel; determining a second respective transmit power, different from the first respective transmit power, of the second channel based on the in-channel frequency response of the second channel, the second transmit power level of the second channel, and the second received power level of the second channel; determining whether a first peak exists in the first respective transmit power and/or second respective transmit power; and in accordance with a determination that the first peak exists, identifying a frequency of the first peak.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 shows a map illustrating an exemplary data network that includes the different types of network devices that can be associated with a suspected point of impairment.

FIG. 2 illustrates an exemplary impairment 200 that may exist in a network.

FIG. 3 shows an exemplary electronic device, in accordance with some embodiments.

FIG. 4 illustrates a frequency response of exemplary impairment, in accordance with some embodiments.

FIG. 5 illustrates the In-Channel Frequency Response (ICFR) of multiple channels of a cable modem.

FIG. 6 illustrates an exemplary table that includes the frequency, bandwidth, SNR, transmit power level, and received power level for various upstream channels of a cable modem.

FIG. 7 illustrates reference power levels for the upstream channels (e.g., including the first, second, and third channels) of the cable modem, in accordance with some embodiments.

FIG. 8 illustrates exemplary process for identifying a network impairment and/or determining a frequency of the network impairment.

### DETAILED DESCRIPTION

The following detailed description sets forth exemplary techniques, methods, parameters, and the like. It should be recognized, however, that such description is not intended as a limitation on the scope of the present disclosure, but is instead provided as a description of exemplary embodiments.

Although the following description uses terms “first,” “second,” etc. to describe various elements, these elements should not be limited by the terms. In some embodiments, these terms are used to distinguish one element from another. For example, a first channel could be termed a second channel, and, similarly, a second channel could be termed a first channel, without departing from the scope of the various described embodiments. In some embodiments, the first channel and the second channel are both channels, but they are not the same channel.

In some embodiments, impairments in a hybrid fiber coaxial (HFC) data network cause noise ingress (e.g., unwanted noise entering the data network from outside of the data network) and noise egress (e.g., signal leakage from the data network to outside the data network). Both noise ingress and signal leakage are undesirable for cable network operators. Noise entering the network can cause packet loss in the data network, service degradation, and possibly cause service outages. Signal leakage can pollute the environment with unwanted RF signals, which can cause interference with third-party electronic equipment and systems. Additionally, noise ingress and signal leakage decrease the efficiency of the cable plan and reduces the quality of the signals between CPE and headend and/or between CPE and cable modem termination system (CMTS).

In some embodiments, upstream noise can be particularly undesirable, due to a funneling effect whereby noise on one upstream channel affects all network devices (e.g., cable modems) that communicate on the upstream channel. In low-split networks, the upstream frequency range is 5 MHz to 42 MHz (or 5 MHz to 65 MHz, such as in some European systems) (e.g., approximately). In mid-split networks, the upstream frequency range is 5 MHz to 85 MHz (e.g., approximately). In the high-split networks, the upstream frequency range is from 5 MHz to 204 MHZ (e.g., such as in networks that are compliant with DOCSIS 3.1 and higher). As a result of the much larger upstream frequency range (e.g., up to 204 MHz) of high-split networks, several challenges arise. First, sources of noise that would otherwise not be on the upstream frequencies (e.g., for low-split and mid-split networks) will now affect the upstream signal, which is more problematic and more difficult to identify than if the noise were on the downstream signal. Second, leakage of the upstream signals (which is more difficult to detect than leakage of downstream signals) can potentially occur in particularly sensitive RF frequencies, such as in the VHF aeronautical band (e.g., 118 MHz to 137 MHz) and other frequencies that are regulated by government authorities.

In some embodiments, the technique determines the In-Channel Frequency Response (ICFR) of one or more network devices and estimates the transmit upstream power required for the one or more network devices at different frequencies. In some embodiments, the transmit upstream power required at different frequencies is the opposite (or inverse) of the frequency response corresponding to the impairment. For example, if a graph of transmit power vs frequency shows a peak, it can be determined that this peak corresponds to a drop (or suckout) in the impairment's frequency response. In some embodiments, a suckout appears as a notch the frequency response of an RF impairment and often spans two (or more) channels.

A suckout in the frequency response of an impairment means that not all the signal power entering the impairment at the suckout frequency (and, optionally, in adjacent frequencies) proceeds past the impairment. Part of the missing power is reflected back towards the source of the signal (e.g., due to impedance mismatch), part of the missing power may be dissipate as heat, and another part of the missing power may be radiated (e.g., if the impairment has an antenna coupling). Therefore, the frequency (ies) of the detected suckouts are prime candidates for signal leakage and noise ingress.

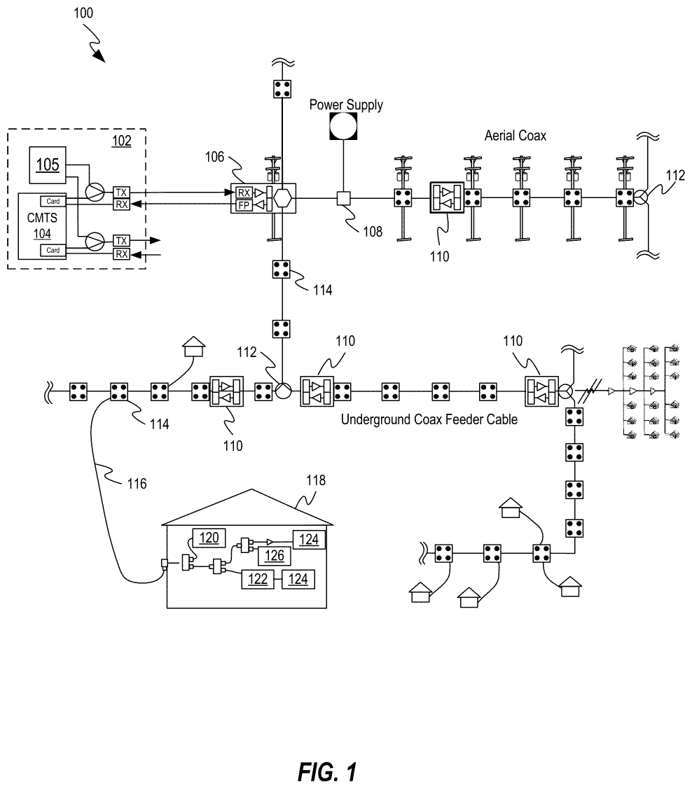

FIG. 1 is an exemplary network map illustrating different network devices used in operating a data network 100. While the techniques of this application could be applied to many different types of data networks, a hybrid fiber coaxial (HFC) data network is used for exemplary purposes only and should not be construed as limiting. An HFC data network generally includes a headend or central office 102 where data network 100 interfaces with a larger internet fiberoptic backbone. Central office 102 includes CMTS 104, which is responsible for handling inbound and outbound data associated with data network 100. Also located at central office 102 is data collection engine 105, which as depicted is capable of transmitting and receiving data from data network 100. Central office 102 is generally connected by fiber lines to a fiber node 106 by fiber lines that are typically less than 20 km in length and can be configured as above or below ground fiber runs. While only a single fiber node 106 is depicted in FIG. 1 it should be appreciated that data network 100 can include multiple fiber nodes. Coaxial cables leaving fiber node 106 can be distributed above or below ground as illustrated in FIG. 1. The aerial coaxial branch includes a power injector 108, which can be configured to provide additional power for longer coaxial cable runs. Data network 100 can also include amplifiers 110 for increasing the signal strength of traffic travelling along coaxial cable of data network 100. Data network 100 also includes directional couplers 112, which manage the distribution of data along different branches of data network 100. Network taps 114, in addition to connecting the residential and commercial users to the network, allow for checking noise and power levels in various portions of data network 100. Residential or commercial users of data network 100 generally receive their signal by way of a drop cable 116. A particular residence or business, as depicted, can include multiple network devices. In particular, exemplary residence 118 includes a cable modem 120, a set top box 122, televisions 124 and telephone 126 that all rely on services provided by data network 100. In some embodiments, the data network includes a direct connection of one or more CMTS devices to the data network (e.g., where signals to/from the CMTS pass directly to RF cable which is feeding a customer), thereby reducing or eliminating the need for fiber node 106 (e.g., central office 102 connects directly to power injector 108). In some embodiments, the data network uses fiber nodes. In some embodiments, the data network uses Distributed Access Architecture (DAA), which utilizes digital fiber links (e.g. Ethernet and PON) and Remote PHY digital nodes. As noted above, the techniques described below are applicable to various networks, including networks that are not HFC data networks.

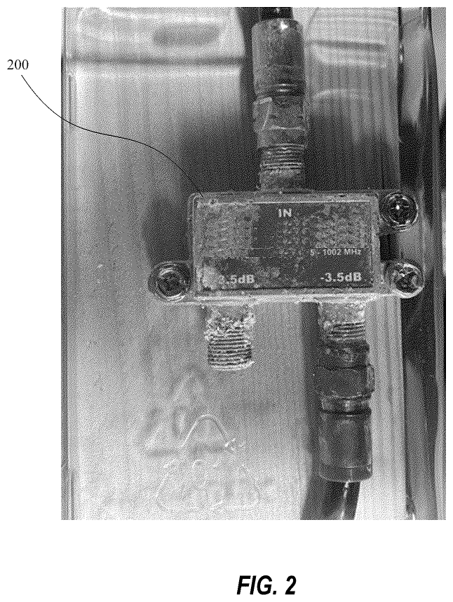

FIG. 2 illustrates an exemplary impairment 200 that may exist in a network (e.g., in data network 100). For example, impairment 200 is a corroded coaxial cable splitter with an unterminated port. In some embodiments, impairment 200 is located within a building (e.g., business or residence 118) of a subscriber and is difficult for the network operator to physically access. In some embodiments, impairment 200 is located outside of a building of a subscriber, such as at or near directional couplers 112, as shown in FIG. 1.

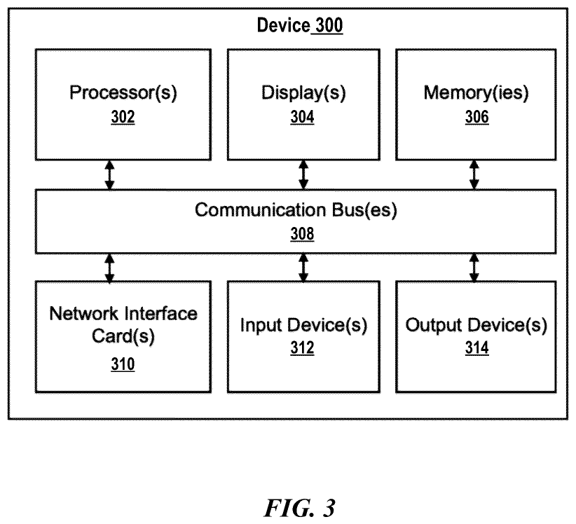

FIG. 3 illustrates an exemplary electronic device (e.g., a server, a computer, or a network device), in accordance with some embodiments. In some examples, the techniques described herein can be performed at device 300. Device 300 is an electronic device with one or more processors 302, one or more displays 304, one or more memories 306, one or more network interface cards 310, one or more input devices (e.g., keyboard 312), one or more output device 314 (e.g., printer), connected via one or more communication buses 308. Many of elements of device 300 are optional, such as display 304, input devices 312, and output devices 314. Memories 306 can include random access memory, read-only memory, flash memory, and the like. In some embodiments, memory 306 is a non-transitory computer-readable storage medium. In some embodiments, memory 306 is a transitory computer-readable storage medium. The computer-readable storage medium is configured to store one or more programs configured to be executed by the one or more processors 302 of device 300. The one or more programs optionally include instructions for performing the described techniques.

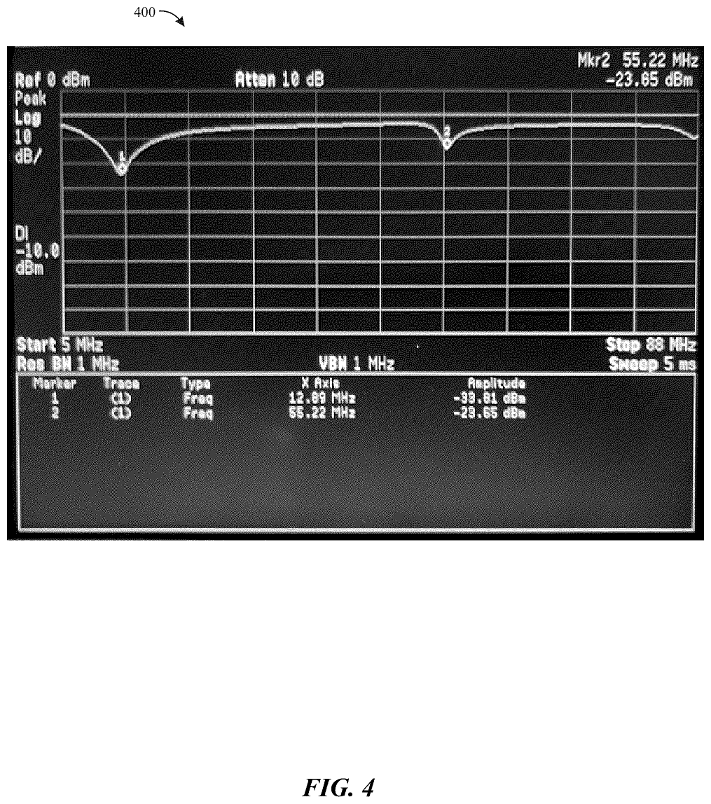

FIG. 4 illustrates a frequency response of exemplary impairment 200 illustrated in FIG. 2, with suckouts at 12.89 MHz and 55.22 MHz, as respectively indicated by the notch at 12.89 MHz (identified as marker 1) and the notch at 55.22 MHz (identifier as marker 2). The frequency response illustrated in graph 400 of FIG. 4 was measured using a spectrum analyzer with tracking generator. The frequency response of a network impairment is typically not known in advance, the location (or existence) of the impairment is not known, and often physical access to the impairment is unavailable or difficult.

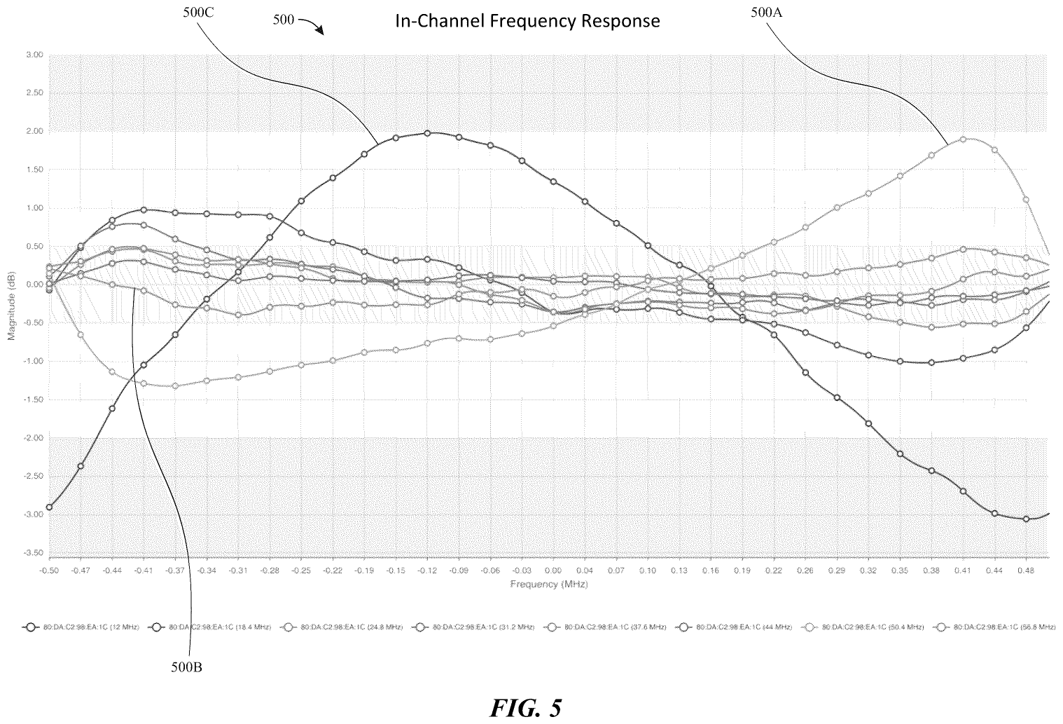

FIG. 5 illustrates individual In-Channel Frequency Response (ICFR) 500 of multiple (eight) channels of a cable modem (e.g., cable modem 120) connected to the network (e.g., data network 100) through impairment 200 of FIG. 2. In some embodiments, the ICFR is based on (e.g., derived from) pre-equalization coefficients. Pre-equalization attempts to improve upstream performance of the cable modem to compensate for network impairments. For example, the CMTS analyzes data received from the cable modem and determines the quality of the received signal. The CMTS determines equalizer adjustment values (e.g., pre-equalization coefficients that will improve the quality of the received signal and/or values across a range of frequencies) and transmits them to the cable modem. The cable modem applies these equalizer adjustment values to its pre-equalizer. The result is that the cable modem transmits a signal that attempts to compensate for impairments that are physically located in the network between the cable modem and the CMTS. As the transmitted signal passes through the network, the signal is affected by the network impairments, thereby changing the signal. This changed signal (data) is received by the CTMS and (ideally) is a higher quality signal than previously received (because of the equalizer adjustment values) and, sometimes, is an ideal signal (e.g., at the desired power level across all frequencies). In some examples, the CMTS analyzes this received data, determines (again) the quality of the signal, determines (again) additional equalizer adjustment values, and transmits (again) new equalizer adjustment values to the cable modem for use at the cable modem pre-equalizer. This process is optionally repeated periodically (e.g., every 5 seconds, every 30 seconds, and/or every 5 minutes). As shown in FIG. 5, the cable modem communicates on eight upstream channels. In some embodiments, one or more (e.g., each) upstream channel has a bandwidth of 6.4 MHz, but is displayed as ranging from −0.5 to +0.5 in FIG. 5 for illustrative purposes. The −0.5 to +0.5 range indicates half of the channel width up and down with central frequency at 0. Channel widths are not limited to 6.4 MHz, and channels with different widths can be analyzed. In some embodiments, all the allowed channel widths specified in DOCSIS specification 3.0 and up can be analyzed. As illustrated in FIG. 5, each channel has a separate ICFR. For example, a first channel (at 50.4 MHz) has ICFR 500A, and a second channel has ICFR 500C (at 56.8 MHz), and a third channel (at 12 MHz) has ICFR 500A. Although ICFR 500 is helpful in understanding impairments in the network, it provides an incomplete picture.

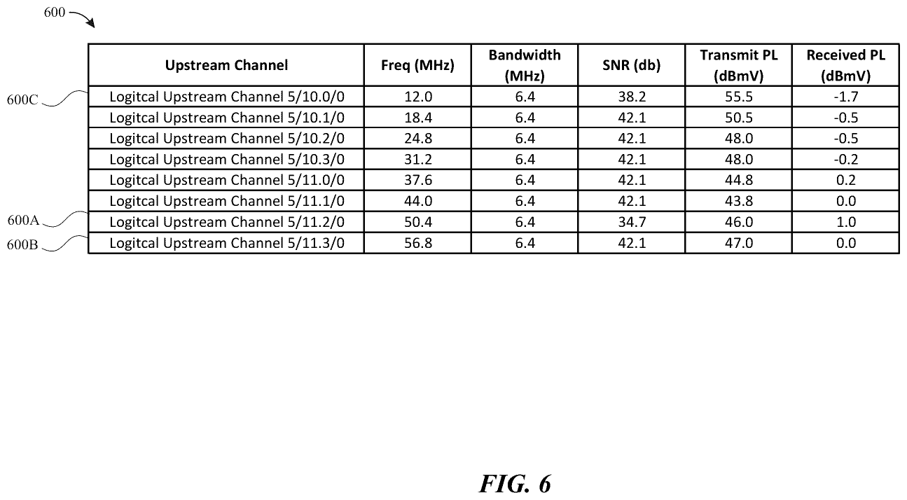

FIG. 6 illustrates exemplary table 600 that includes the frequency, bandwidth, SNR, transmit power level (of signals transmitted from the cable modem to the CMTS), and received power level (of signals received at the CMTS from the cable modem) for various upstream channels of the cable modem. For example, row 600A corresponds to the first channel (at 50.4 MHz) with ICFR 500A, row 600B corresponds to the second channel (at 56.8 MHz) with ICFR 500B, and row 600C corresponds to the third channel (at 12 MHz) with ICFR 500C. Table 600 indicates at row 600A that the first channel (at 50.4 MHz) is transmitting at 46 dBmV (after pre-equalization) and that the CMTS is receiving the signal at 1 dBmV.

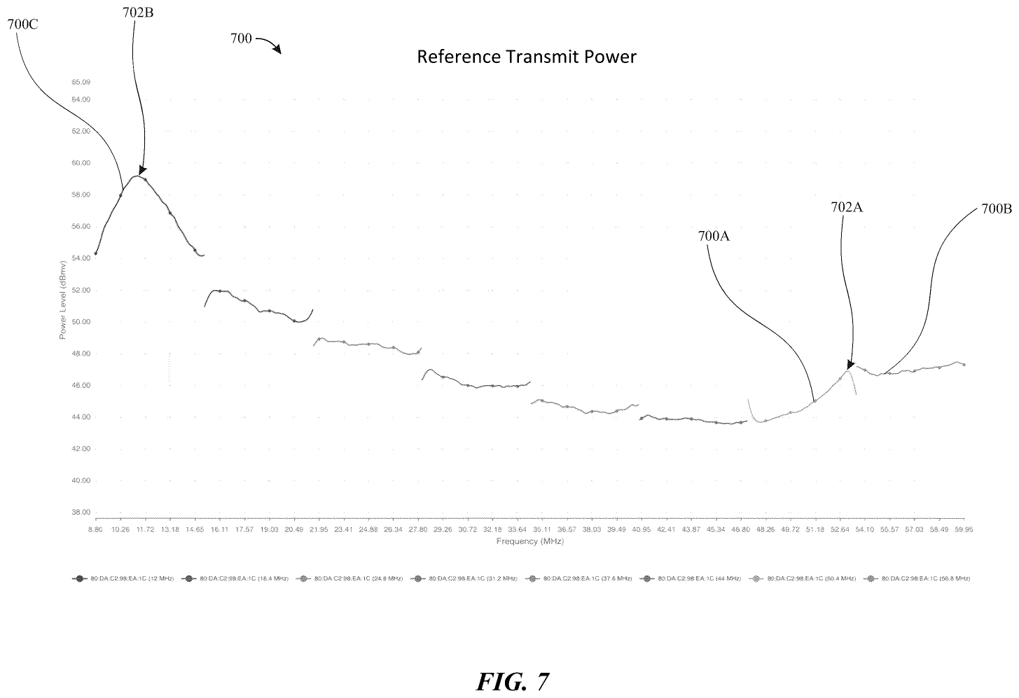

FIG. 7 illustrates reference power levels for the upstream channels (e.g., including the first, second, and third channels) of the cable modem, plotted against power level (Y-axis) and frequency (X-axis). The reference power level is determined on a channel-by-channel basis, whereby the transmit power level (from table 600) is added to the ICFR for the channel, and the received power level (from table 600) is subtracted from the result. In some embodiments, a CMTS set point (or expected receive power) is also added to the result. For the example shown in FIGS. 5-7, the CMTS set point is set to zero (0), and therefore does not change the result. In some embodiments, the reference power level (for a respective channel)=ICFR+Transmit Power+ (CMTS Expected Receive Power-CMTS Actual Receive Power). As also illustrated in FIG. 7, the reference transmit power for each channel is plotted at the appropriate frequency based on the frequency and/or bandwidth of the respective channels.

As an example, ICFR 500A for the first channel is plotted with a vertical position that is based on (e.g., equal to) 46.0 dBmV+ (0-1 dBmV)=45 dBmV. Further, ICFR 500A for the first channel is plotted with a horizontal position that is based on (e.g., equal to and/or centered at) 50.4 MHZ. As another example, ICFR 500B for the second channel is plotted with a vertical position that is based on (e.g., equal to) 47.0 dBmV+ (0-0 dBmV)=47 dBmV. Further, ICFR 500B for the second channel is plotted with a horizontal position that is based on (e.g., equal to and/or centered at) 56.8 MHz. As another example, ICFR 500C for the third channel is plotted with a vertical position that is based on (e.g., equal to) 55.5 dBmV+ (0-(−1.7) dBmV)=57.2 dBmV. Further, ICFR 500C for the third channel is plotted with a horizontal position that is based on (e.g., equal to and/or centered at) 12 MHz. Other channels (e.g., all other upstream channels of the cable modem) are optionally also similarly plotted, as shown in FIG. 7.

As shown in FIG. 7, multiple peaks can be identified using various techniques (e.g., local maximum analysis, window search analysis, and/or first derivative analysis). For example, first peak 702A is identified based on analysis of both 700A and 700B (e.g., based on first peak 702A residing at or near a junction of the two channels). In particular, first peak 702A resides at approximately 54 MHz. Thus, first peak 702A is optionally identified based on analyzing both 700A and 700B (and, optionally, cannot be identified based on analyzing just one of 700A and 700B). For another example, second peak 702B is identified based on analysis of 700C (e.g., based on second peak 702B not residing at or near a junction of two channels). In particular, second peak 702B resides at approximately 11 MHz.

In some embodiments, first peak 702A at 54 MHz corresponds to the suckout at 55.22 MHz shown in FIG. 4 and second peak 702B at corresponds to the suckout at 12.89 MHz shown in FIG. 4. Accordingly, it is determined that there is strong leakage and/or ingress at these frequencies (54 MHz and 11 MHz). For example, first peak 702A may correspond to the corroded coaxial cable splitter (impairment 200).

The same technique can optionally performed on multiple cable modems (e.g., all channels of 5, 10, or 50 other cable modems) to determine which other cable modems (if any) also experience suckouts at the same (or similar frequencies) (e.g., by determining graph 700 for the 5, 10, or 50 other cable modems and identifying peaks). For example, a correlation technique can be applied to identify multiple cable modems with corresponding suckouts (that correlate to one another). This information is then used to localize the physical location of the impairment. For example, if only a single cable modem experiences the effects of the impairment, the impairment is likely physically near the cable modem or if multiple cable modems experience the effects of the impairment, the impairment is at a position in the network that affects those cable modems (and not other cable modems).

Further, this technique enables easy determination of what frequencies the identified impairment will likely affect. For example, based on the identified frequencies (54 MHz and 11 MHz) at the two peaks (702A and 702B), it is determined that the impairments do not affect (or are unlikely to affect) the VHF aeronautical band (e.g., 118 MHz to 137 MHz) and thus an appropriate priority level can be assigned to repairing the impairments.

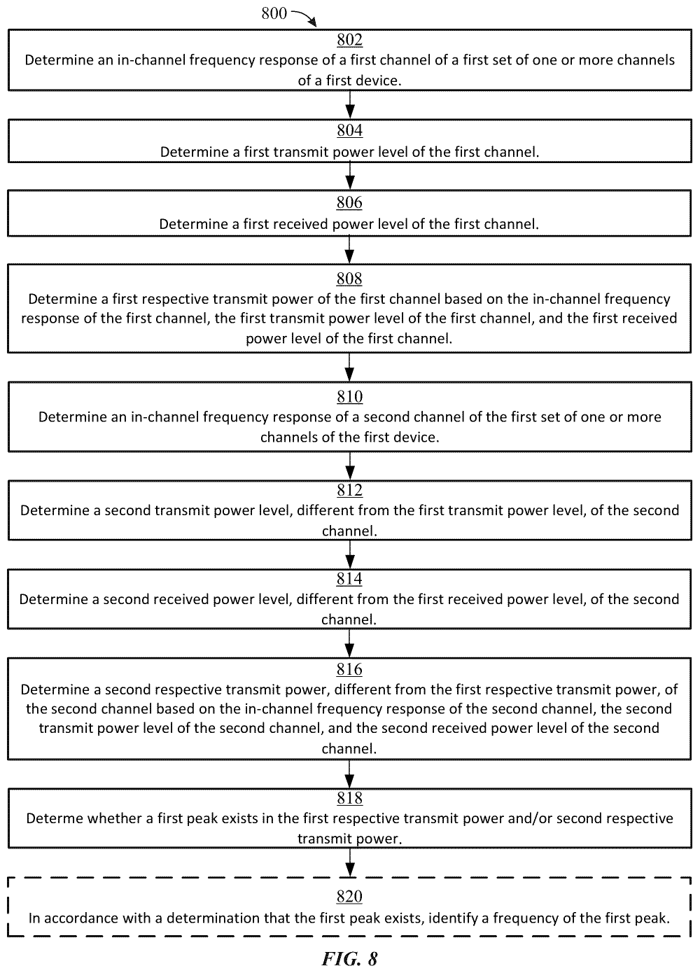

FIG. 8 illustrates exemplary process 800 for identifying a network impairment and/or determining a frequency of the network impairment. The operations of process 800 can be reordered, some operations can be removed, and operations can be added. Process 800 can be performed, for example, by electronic device 300 (e.g., the process can be performed by processors 302 performing instructions stored in memories 306).

At block 802, the electronic device determines (e.g., by calculating, by measuring, and/or by receiving from the first device or from the CMTS) an in-channel frequency response (e.g., 500A) (e.g., a transmit signal frequency response and/or for an upstream signal transmitted by the first device) of a first channel of a first set of one or more channels (e.g., RF communication channels) of a first device (e.g., a network device and/or a cable modem).

At block 804, the electronic device determines (e.g., by calculating and/or by receiving from the first device) a first transmit power level (e.g., 46.0 dBmV, as in row 600A of FIG. 6) (e.g., for the signal transmitted by the cable modem, such as in dBmV) of the first channel.

At block 806, the electronic device determines (e.g., by calculating and/or by receiving from the CMTS) a first received power level (e.g., 1 dBmV, as in row 600A of FIG. 6) (e.g., for the signal transmitted by the cable modem, such as in dBmV) of the first channel.

In some embodiments, the electronic device determines (e.g., by receiving information from the CMTS), a CMTS set point (also referred to as the expected receive power) (e.g., for the CMTS and/or for the cable modem). In some embodiments, the electronic device determines a first CMTS set point (also referred to as the expected receive power) for the first channel (e.g., that is specific to the first channel).

At block 808, the electronic device determines a first respective transmit power (e.g., 700A) (e.g., a reference transmit power, a desired transmit power, an estimated transmit power, a requested (e.g., by the CTMS) transmit power, and/or a required (e.g., by the CMTS) transmit power) (e.g., across a frequency range of the first channel) of the first channel based on the in-channel frequency response (500A) of the first channel, the first transmit power level (by cable modem in dBmV) of the first channel, and the first received power level (by the CMTS in dBmV) of the first channel. In some embodiments, the first respective transmit power is based on a CMTS set point (e.g., the first CMTS set point). In some embodiments, the first respective transmit power is based on (or is) the amount of power with which a signal needs to be transmitted by the transmitter of the first device using the first upstream channel through the transmission line so that the signal will be received flat by the receiver (e.g., the CMTS) on the other end of the transmission line.

At block 810, the electronic device determines (e.g., by calculating, by measuring, and/or by receiving from the first device or from the CMTS) an in-channel frequency response (e.g., 500B) (e.g., a transmit signal frequency response and/or for an upstream signal transmitted by the first device) of a second channel of the first set of one or more channels of the first device.

At block 812, the electronic device determines (e.g., by calculating and/or by receiving from the first device) a second transmit power level (e.g., 47 dBmV, as in row 600B of FIG. 6) (e.g., for the signal transmitted by the cable modem, such as in dBmV), different from the first transmit power level, of the second channel. In some embodiments, the first transmit power and the second transmit power are independent from each other (e.g., determined independently), but have the same value (e.g., both are 46.5 dBmV).

At block 814, the electronic device determines (e.g., by calculating and/or by receiving from the CMTS) a second received power level (e.g., 0.0 dBmV, as in row 600B of FIG. 6) (e.g., for the signal transmitted by the cable modem, such as in dBmV), different from the first received power level, of the second channel.

In some embodiments, the electronic device determines (e.g., by receiving information from the CMTS), a second CMTS set point (also referred to as the expected receive power) for the second channel. In some embodiments, the first and second CMTS set points are different. In some embodiments, the first and second CMTS set points are the same. In some embodiments, the set point is the same for all upstream channels.

At block 816, the electronic device determines a second respective transmit power (e.g., 700B) (e.g., a reference transmit power, a desired transmit power, an estimated transmit power, a requested (e.g., by the CTMS) transmit power, and/or a required (e.g., by the CMTS) transmit power) (e.g., across a frequency range of the first channel), different from the first respective transmit power, of the second channel based on the in-channel frequency response of the second channel (500B), the second transmit power level (by cable modem in dBmV) of the second channel, and the second received power level (by the CMTS in dBmV) of the second channel. In some embodiments, the second respective transmit power is based on a CMTS set point (e.g., the second CMTS set point). In some embodiments, the second respective transmit power is based on (or is) the amount of power with which a signal needs to be transmitted by the transmitter of the first device using the second upstream channel through the transmission line so that the signal will be received flat by the receiver (e.g., the CMTS) on the other end of the transmission line.

At block 818, the electronic device determines (e.g., using the first respective transmit power and/or second respective transmit power) whether a first peak (e.g., 702A) (e.g., a local maximum and/or a frequency at which the respective transmit power is high as compared to the respective transmit power of neighboring frequencies) (e.g., with first peak characteristics) exists in the first respective transmit power (e.g., 700A) and/or second respective transmit power (e.g., 700B) (e.g., within the first respective transmit power, within the second respective transmit power, at a junction of the first respective transmit power and the second respective transmit power).

In some embodiments, at block 820, in accordance with a determination that the first peak (e.g., 702A) exists, he computer system identifies a frequency (e.g., 54 MHz) of the first peak (e.g., 702A). In some embodiments, when the first does not exist (e.g., there does not appear to be an impairment), the frequency of the first peak is not identified.

In some embodiments, determining the first respective transmit power of the first channel includes: adding the first transmit power level of the first channel to the in-channel frequency response of the first channel and subtracting the first received power level (by the CMTS in dBmV) of the first channel (e.g., respective transmit power=in-channel frequency response (e.g., in dB)+transmit power level (e.g., in dBmV)−received power level (e.g., in dBmV)).

In some embodiments, the electronic device displays a graph (e.g., 700 at FIG. 7), including displaying the first respective transmit power of the first channel (e.g., 700A) at a first horizontal position of the graph and at a first vertical position of the graph (e.g., 700), wherein the first horizontal position is based on a frequency range of the first channel and the first vertical position is based on the first transmit power level (e.g., transmitted by cable modem, such as in dBmV) of the first channel and the first received power level (e.g., received at the CMTS, such as in dBmV) of the first channel.

In some embodiments, displaying the graph includes displaying the second respective transmit power (e.g., 700B and/or 700C) of the second channel at a second horizontal position of the graph and at a second vertical position of the graph (e.g., 700), wherein the second horizontal position is based on a frequency range of the second channel and the second vertical position is based on the second transmit power level (e.g., transmitted by cable modem, such as in dBmV) of the second channel and the second received power level (e.g., received at the CMTS, such as in dBmV) of the second channel.

In some embodiments, the electronic device identifies (and, optionally, outputting, such as via audio output and/or display output), using the frequency of the first peak, an impairment frequency of a signal leak and/or noise ingress caused by an impairment. In some embodiments, the impairment frequency is the same as the frequency of the first peak.

In some embodiments, the electronic device determines, based on the first respective transmit power (e.g., 700A), whether a threshold transmit power (e.g., a maximum permissible transmit power of the cable modem) for the first channel has been exceeded. In some embodiments, the electronic device similarly determines, based on the second respective transmit power, whether a threshold transmit power for the second channel has been exceeded.

In some embodiments, determining whether the first peak exists includes determining whether a respective peak meets first peak characteristics that includes a threshold peak height.

In some embodiments, determining whether the first peak exists includes performing peak analysis (e.g., of the first respective transmit power and/or of the second respective transmit power) using one or more of: local maximum analysis, window search analysis, and/or first derivative analysis (e.g., of the first respective transmit power and/or of the second respective transmit power).

In some embodiments, the electronic device determines a third respective transmit power for the first channel of a second device that is different from the first device, determines a fourth respective transmit power for the second channel of the second device, determines (e.g., using the third respective transmit power and/or fourth respective transmit power) whether a second peak (e.g., a local maximum and/or a frequency at which the respective transmit power is high as compared to the respective transmit power of neighboring frequencies) (e.g., with second peak characteristics) exists in the third respective transmit power and/or fourth respective transmit power (e.g., within the third respective transmit power, within the fourth respective transmit power, at a junction of the third respective transmit power and the fourth respective transmit power), determines that the second peak exists, and (optionally) identifies a frequency of the second peak. In some embodiments, the electronic device localizes, based on a determination that the second peak corresponds to the first peak (e.g., the second peak is within a threshold frequency of the first peak), an impairment (e.g., 200) within a network (e.g., 100) (of which the first device and the second device are members).

In some embodiments, respective transmit powers (e.g., determined based on ICFR, transmit power, and/or received power) are determined for every upstream channel (e.g., all 8 channels as shown in FIG. 7) of the first device (e.g., prior to performing the peak analysis to identify peaks). In some embodiments, respective transmit powers for all channels of multiple modems are determined and peak analysis is performed for each modem.

In some embodiments, determining whether the first peak exists includes determining that the first peak exists based on data from both the first respective transmit power and the second respective transmit power. In some embodiments, the first peak exists at an edge or junction of first respective transmit power and the second respective transmit power (e.g., the peak is formed by the first respective transmit power and the second respective transmit power). In some embodiments, the first peak cannot be identified based on the first respective transmit power and without the second respective transmit power. Instead, both the first respective transmit power and the second respective transmit power are needed (and used) to identify the first peak.

The foregoing description has been described with reference to specific embodiments. However, the illustrative discussions above are not intended to be exhaustive or to limit the invention to the precise forms described. Many modifications and variations are possible in view of the above teachings. Others skilled in the art are thereby enabled to best utilize the techniques and various embodiments with various modifications as suited to various uses.

Although the disclosure and examples have been described with reference to the accompanying drawings, it is to be noted that various changes and modifications will become apparent to those skilled in the art. Such changes and modifications are to be understood as being included within the scope of the disclosure.

What is claimed is:

1. A method, comprising:
at an electronic device:
determining an in-channel frequency response of a first channel of a first set of one or more channels of a first device;
determining a first transmit power level of the first channel;
determining a first received power level of the first channel;
determining a first respective transmit power of the first channel based on the in-channel frequency response of the first channel, the first transmit power level of the first channel, and the first received power level of the first channel;
determining an in-channel frequency response of a second channel of the first set of one or more channels of the first device;
determining a second transmit power level, different from the first transmit power level, of the second channel;
determining a second received power level, different from the first received power level, of the second channel;
determining a second respective transmit power, different from the first respective transmit power, of the second channel based on the in-channel frequency response of the second channel, the second transmit power level of the second channel, and the second received power level of the second channel;
determining whether a first peak exists in the first respective transmit power and/or second respective transmit power; and
in accordance with a determination that the first peak exists, identifying a frequency of the first peak.

2. The method of claim 1, wherein determining the first respective transmit power of the first channel includes: adding the first transmit power level of the first channel to the in-channel frequency response of the first channel and subtracting the first received power level of the first channel.

3. The method of claim 1, further comprising:
displaying a graph, including displaying the first respective transmit power of the first channel at a first horizontal position of the graph and at a first vertical position of the graph, wherein the first horizontal position is based on a frequency range of the first channel and the first vertical position is based on the first transmit power level of the first channel and the first received power level of the first channel.

4. The method of claim 3, wherein displaying the graph includes:
displaying the second respective transmit power of the second channel at a second horizontal position of the graph and at a second vertical position of the graph, wherein the second horizontal position is based on a frequency range of the second channel and the second vertical position is based on the second transmit power level of the second channel and the second received power level of the second channel.

5. The method of claim 1, further comprising:
identifying, using the frequency of the first peak, an impairment frequency of a signal leak and/or noise ingress caused by an impairment.

6. The method of claim 1, further comprising:
determining, based on the first respective transmit power, whether a threshold transmit power for the first channel has been exceeded.

7. The method of claim 1, wherein determining whether the first peak exists includes:
determining whether a respective peak meets first peak characteristics that includes a threshold peak height.

8. The method of claim 1, wherein determining whether the first peak exists includes performing peak analysis using local maximum analysis, window search analysis, and/or first derivative analysis.

9. The method of claim 1, further comprising:
determining a third respective transmit power for the first channel of a second device that is different from the first device;
determining a fourth respective transmit power for the second channel of the second device;
determining whether a second peak exists in the third respective transmit power and/or fourth respective transmit power;
determining that the second peak exists;
identifying a frequency of the second peak; and
localizing, based on a determination that the second peak corresponds to the first peak, an impairment within a network.

10. The method of claim 1, wherein respective transmit powers are determined for every upstream channel of the first device.

11. The method of claim 1, wherein determining whether the first peak exists includes determining that the first peak exists based on data from both the first respective transmit power and the second respective transmit power.

12. A non-transitory computer-readable storage medium storing one or more programs configured to be executed by one or more processors of an electronic device, the one or more programs including instructions for:
determining an in-channel frequency response of a first channel of a first set of one or more channels of a first device;
determining a first transmit power level of the first channel;
determining a first received power level of the first channel;
determining a first respective transmit power of the first channel based on the in-channel frequency response of the first channel, the first transmit power level of the first channel, and the first received power level of the first channel;
determining an in-channel frequency response of a second channel of the first set of one or more channels of the first device;
determining a second transmit power level, different from the first transmit power level, of the second channel;
determining a second received power level, different from the first received power level, of the second channel;
determining a second respective transmit power, different from the first respective transmit power, of the second channel based on the in-channel frequency response of the second channel, the second transmit power level of the second channel, and the second received power level of the second channel;
determining whether a first peak exists in the first respective transmit power and/or second respective transmit power; and
in accordance with a determination that the first peak exists, identifying a frequency of the first peak.

13. The non-transitory computer-readable storage medium of claim 12, wherein determining the first respective transmit power of the first channel includes: adding the first transmit power level of the first channel to the in-channel frequency response of the first channel and subtracting the first received power level of the first channel.

14. The non-transitory computer-readable storage medium of claim 12, the one or more programs including instructions for:
displaying a graph, including displaying the first respective transmit power of the first channel at a first horizontal position of the graph and at a first vertical position of the graph, wherein the first horizontal position is based on a frequency range of the first channel and the first vertical position is based on the first transmit power level of the first channel and the first received power level of the first channel.

15. The non-transitory computer-readable storage medium of claim 14, wherein displaying the graph includes:
displaying the second respective transmit power of the second channel at a second horizontal position of the graph and at a second vertical position of the graph, wherein the second horizontal position is based on a frequency range of the second channel and the second vertical position is based on the second transmit power level of the second channel and the second received power level of the second channel.

16. The non-transitory computer-readable storage medium of claim 12, the one or more programs including instructions for:
identifying, using the frequency of the first peak, an impairment frequency of a signal leak and/or noise ingress caused by an impairment.

17. The non-transitory computer-readable storage medium of claim 12, the one or more programs including instructions for:
determining, based on the first respective transmit power, whether a threshold transmit power for the first channel has been exceeded.

18. The non-transitory computer-readable storage medium of claim 12, wherein determining whether the first peak exists includes:
determining whether a respective peak meets first peak characteristics that includes a threshold peak height.

19. The non-transitory computer-readable storage medium of claim 12, wherein determining whether the first peak exists includes performing peak analysis using local maximum analysis, window search analysis, and/or first derivative analysis.

20. The non-transitory computer-readable storage medium of claim 12, the one or more programs including instructions for:
determining a third respective transmit power for the first channel of a second device that is different from the first device;
determining a fourth respective transmit power for the second channel of the second device;
determining whether a second peak exists in the third respective transmit power and/or fourth respective transmit power;
determining that the second peak exists;
identifying a frequency of the second peak; and
localizing, based on a determination that the second peak corresponds to the first peak, an impairment within a network.

21. The non-transitory computer-readable storage medium of claim 12, wherein respective transmit powers are determined for every upstream channel of the first device.

22. The non-transitory computer-readable storage medium of claim 12, wherein determining whether the first peak exists includes determining that the first peak exists based on data from both the first respective transmit power and the second respective transmit power.

23. An electronic device, comprising:
one or more processors; and
memory storing one or more programs configured to be executed by the one or more processors, the one or more programs including instructions for:
determining an in-channel frequency response of a first channel of a first set of one or more channels of a first device;
determining a first transmit power level of the first channel;
determining a first received power level of the first channel;
determining a first respective transmit power of the first channel based on the in-channel frequency response of the first channel, the first transmit power level of the first channel, and the first received power level of the first channel;
determining an in-channel frequency response of a second channel of the first set of one or more channels of the first device;
determining a second transmit power level, different from the first transmit power level, of the second channel;
determining a second received power level, different from the first received power level, of the second channel;
determining a second respective transmit power, different from the first respective transmit power, of the second channel based on the in-channel frequency response of the second channel, the second transmit power level of the second channel, and the second received power level of the second channel;
determining whether a first peak exists in the first respective transmit power and/or second respective transmit power; and
in accordance with a determination that the first peak exists, identifying a frequency of the first peak.

24. The electronic device of claim 23, wherein determining the first respective transmit power of the first channel includes: adding the first transmit power level of the first channel to the in-channel frequency response of the first channel and subtracting the first received power level of the first channel.

25. The electronic device of claim 23, the one or more programs including instructions for:
displaying a graph, including displaying the first respective transmit power of the first channel at a first horizontal position of the graph and at a first vertical position of the graph, wherein the first horizontal position is based on a frequency range of the first channel and the first vertical position is based on the first transmit power level of the first channel and the first received power level of the first channel.

26. The electronic device of claim 25, wherein displaying the graph includes:
displaying the second respective transmit power of the second channel at a second horizontal position of the graph and at a second vertical position of the graph, wherein the second horizontal position is based on a frequency range of the second channel and the second vertical position is based on the second transmit power level of the second channel and the second received power level of the second channel.

27. The electronic device of claim 23, the one or more programs including instructions for:
identifying, using the frequency of the first peak, an impairment frequency of a signal leak and/or noise ingress caused by an impairment.

28. The electronic device of claim 23, the one or more programs including instructions for:
determining, based on the first respective transmit power, whether a threshold transmit power for the first channel has been exceeded.

29. The electronic device of claim 23, wherein determining whether the first peak exists includes:
determining whether a respective peak meets first peak characteristics that includes a threshold peak height.

30. The electronic device of claim 23, wherein determining whether the first peak exists includes performing peak analysis using local maximum analysis, window search analysis, and/or first derivative analysis.

31. The electronic device of claim 23, the one or more programs including instructions for:
determining a third respective transmit power for the first channel of a second device that is different from the first device;
determining a fourth respective transmit power for the second channel of the second device;
determining whether a second peak exists in the third respective transmit power and/or fourth respective transmit power;
determining that the second peak exists;
identifying a frequency of the second peak; and
localizing, based on a determination that the second peak corresponds to the first peak, an impairment within a network.

32. The electronic device of claim 23, wherein respective transmit powers are determined for every upstream channel of the first device.

33. The electronic device of claim 23, wherein determining whether the first peak exists includes determining that the first peak exists based on data from both the first respective transmit power and the second respective transmit power.
